(19) United States
(12) Patent Application Publication
(10) Pub. No.: US 2025/0093141 A1
(43) Pub. Date: Mar. 20, 2025

(54) SHOTCRETE GAUGE

(71) Applicant: JDL Industries Inc., Hanmer (CA)

(72) Inventor: John-David DANDENO, Hanmer (CA)

(21) Appl. No.: 18/480,696

(22) Filed: Oct. 4, 2023

(30) Foreign Application Priority Data
Sep. 15, 2023 (CA) 3212670

(51) Int. Cl. G01B 3/28; E21D 11/10; G01B 5/06

(52) U.S. Cl. CPC G01B 3/28; E21D 11/10; G01B 5/06

(57) ABSTRACT

A shotcrete gauge for facilitating an application of shotcrete to a surface, the shotcrete gauge comprising a main body, a pair of twist-on members having parallel hooks to attach to a reinforcement mesh disposed against the surface and a fastener-supporting bore extending centrally inside the main body and having internal threads for receiving a depth-setting fastener having corresponding external threads. The depth-setting fastener can be a depth-setting bolt having a bolt head and a threaded shank having the external threads, wherein the bolt head provides a visual indicator for a user applying the shotcrete to the reinforcement mesh.

### CROSS-REFERENCE TO RELATED APPLICATIONS

This application claims benefit to Canadian application no. 3,212,670, filed 15 Sep. 2023, which is hereby incorporated by reference in its entirety.

### TECHNICAL FIELD

The present invention relates generally to shotcrete and, more particularly, to a gauge for applying shotcrete.

### BACKGROUND

In the field of concrete construction, concrete walls, ceilings, and other concrete surfaces can be formed using shotcrete. Shotcrete is a technique whereby a mixture of cement, sand, fine aggregate, and water is sprayed at high velocity onto a surface, usually onto a reinforcing material such as steel rods (rebar) or steel mesh placed on the surface. The shotcrete is sprayed onto the surface, where it hardens to encase the reinforcing material.

In the mining industry, shotcrete is frequently applied to underground tunnels, drifts or any other such underground locations to minimize the risk of rockfalls. The shotcrete is applied by projecting the shotcrete usually onto a reinforcing mesh that is first secured to the tunnel, drift or other location.

A recurring challenge with shotcrete, whether in mines or elsewhere, is to apply it in a desired depth or thickness. Often the shotcrete is either too thinly applied or too thickly applied. A solution to this technical problem is disclosed in this specification.

### SUMMARY

In general, the present invention is a shotcrete gauge, i.e. a gauge (tool) that facilitates the application of shotcrete. The shotcrete gauge includes a main body, a pair of twist-on retaining members and a threaded bore for receiving a fastener. The shotcrete gauge can receive one of a plurality of different fasteners (e.g. bolts) of different lengths that can be selectively threaded onto the shotcrete gauge to provide different thicknesses.

An aspect of the disclosure is a shotcrete gauge for facilitating an application of shotcrete to a surface, the shotcrete gauge comprising a main body, a pair of twist-on members having parallel hooks to attach to a reinforcement mesh disposed against the surface and a fastener-supporting bore extending centrally inside the main body and having internal threads for receiving a depth-setting fastener having corresponding external threads. Optionally, in one implementation, the depth-setting fastener can be a depth-setting bolt having a bolt head and a threaded shank having the external threads, wherein the bolt head provides a visual indicator for a user applying the shotcrete to the reinforcement mesh.

Another aspect of the disclosure is a shotcrete gauge for applying shotcrete, the shotcrete gauge comprising a main body, a pair of twist-on members having hooks to attach to a reinforcement mesh and a fastener-supporting bore extending inside the main body and having internal threads for receiving a depth-setting fastener having corresponding external threads.

Another aspect of the disclosure is a method of applying shotcrete to a surface, the method comprising attaching a reinforcement mesh to the surface and attaching a shotcrete gauge to the reinforcement mesh. The shotcrete gauge comprises a main body, a pair of twist-on members having parallel hooks to attach to a reinforcement mesh disposed against the surface and a fastener-supporting bore extending centrally inside the main body and having internal threads for receiving a depth-setting fastener having corresponding external threads. The method further entails fastening the depth-setting fastener in the fastener-supporting bore to set a depth of the shotcrete. The method may further entails applying the shotcrete to the surface using the gauge to visually determine the correct depth or thickness of the shotcrete.

The foregoing presents a simplified summary of the invention in order to provide a basic understanding of some aspects of the invention. This summary is not an exhaustive overview of the invention. It is not intended to identify essential, key or critical elements of the invention or to delineate the scope of the invention. Its sole purpose is to present some concepts in a simplified form as a prelude to the more detailed description that is discussed later. Other aspects of the invention are described below in relation to the accompanying drawings.

### BRIEF DESCRIPTION OF THE DRAWINGS

Further features and advantages of the present technology will become apparent from the following detailed description, taken in combination with the appended drawings, in which:

FIG. 1 is a front isometric view of a shotcrete gauge in accordance with an embodiment of the present invention.

FIG. 2 is a rear isometric view of the shotcrete gauge of FIG. 1.

FIG. 3 is a first side view of the shotcrete gauge of FIG. 1.

FIG. 4 is a top view of the shotcrete gauge of FIG. 1.

FIG. 5 is a bottom view of the shotcrete gauge of FIG. 1.

FIG. 6 is a second side view of the shotcrete gauge of FIG. 1.

FIG. 7 is a cross-sectional view of the shotcrete gauge of FIG. 1.

FIG. 8 is a photograph showing the shotcrete gauge attached to a mesh.

FIG. 9 is a photograph showing the shotcrete gauge with a depth-setting bolt fastened to the shotcrete gauge.

FIG. 10 is another photograph showing the shotcrete gauge with the depth-setting bolt fastened to the shotcrete gauge.

It will be noted that throughout the appended drawings, like features are identified by like reference numerals.

### DETAILED DESCRIPTION

Disclosed herein is a shotcrete gauge for applying shotcrete to a surface, in particular for applying shotcrete to a surface against which a reinforcement mesh has been placed. For the purposes of this specification, the expression “shotcrete” is to be interpreted broadly to encompass any form of sprayed concrete, including both wet-mix and dry-mix versions (including gunite). The shotcrete gauge may be used in mines or in any other concrete construction such surfaces of highway tunnels, subways, swimming pools, walls, buildings, or other civil engineering structures like tanks, domes, etc.

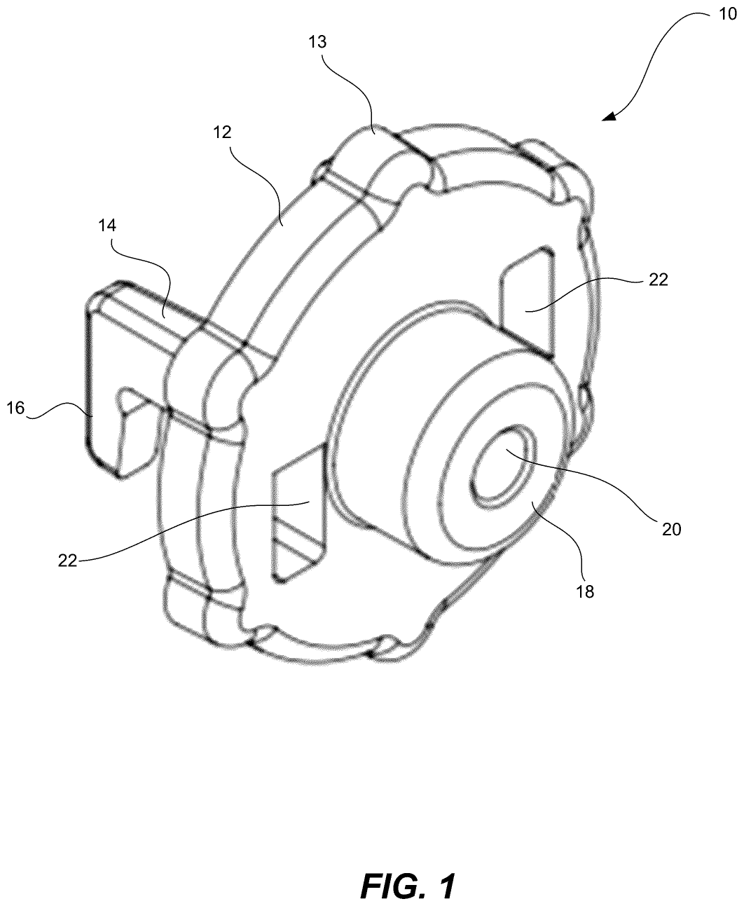

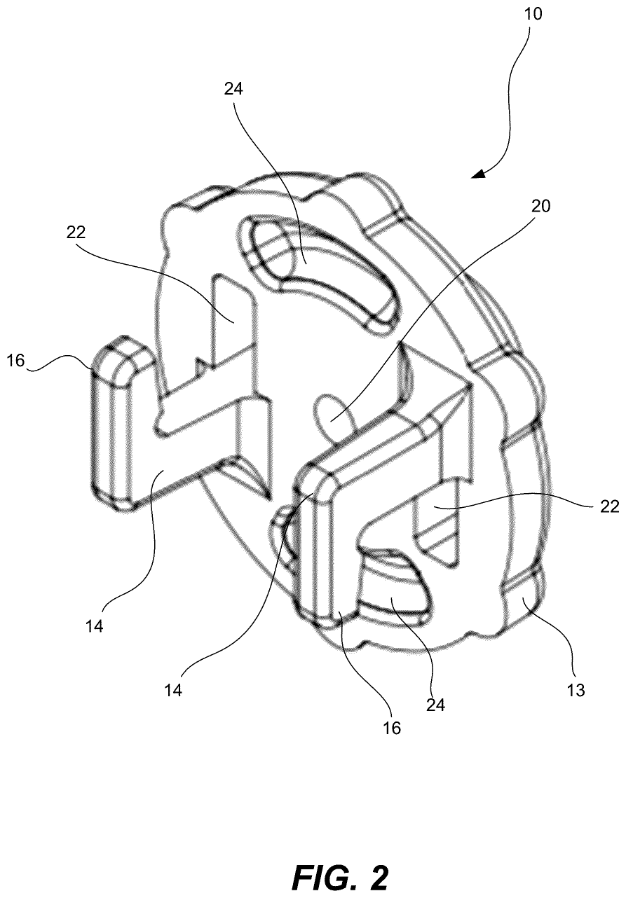

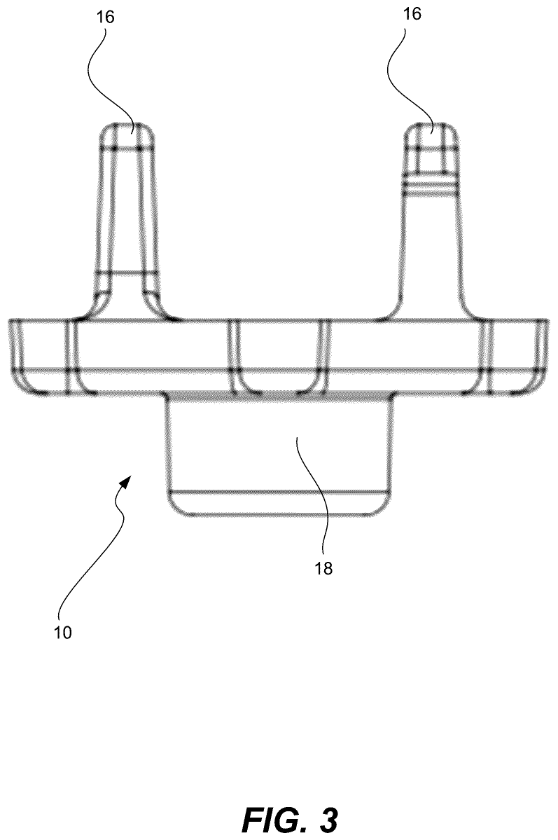

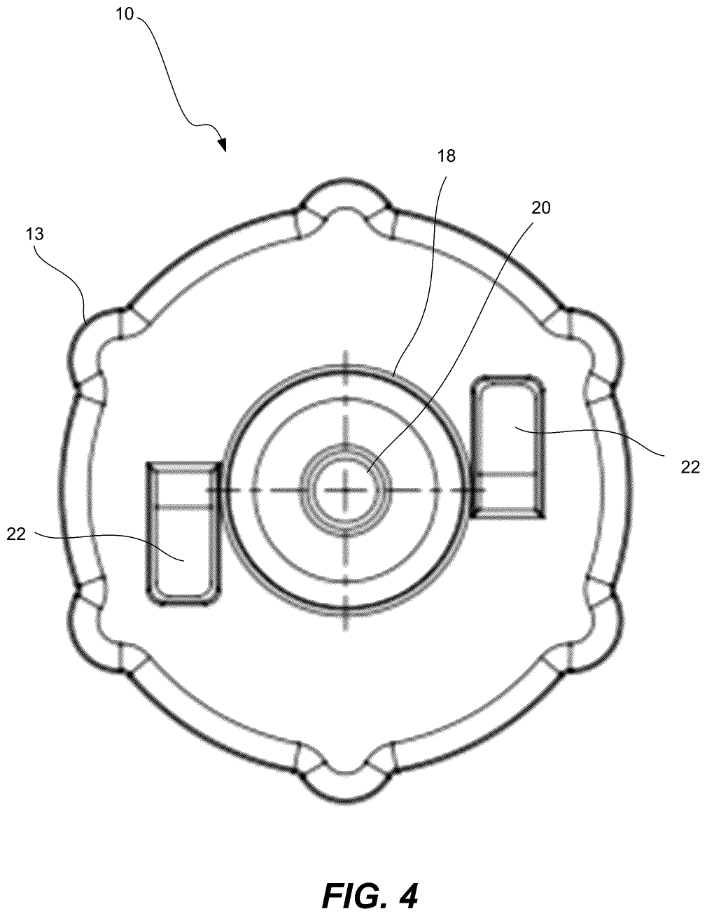

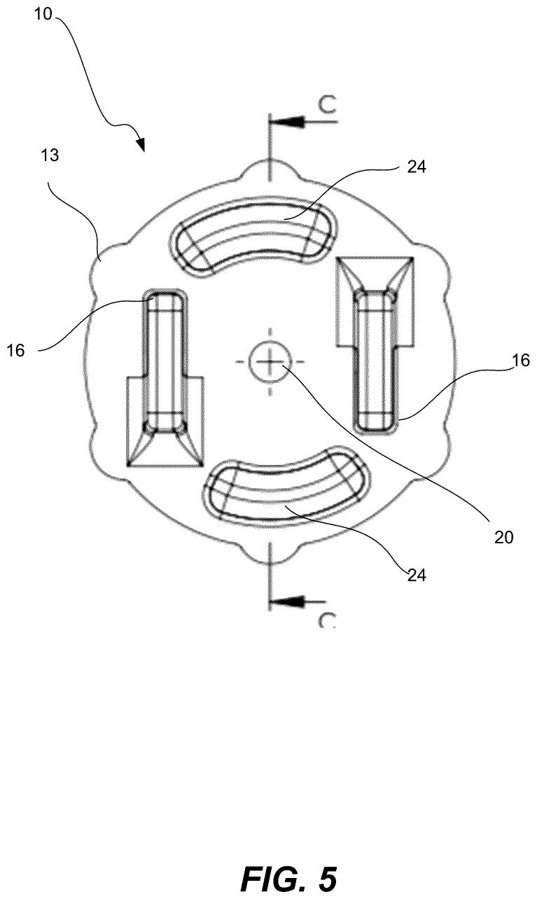

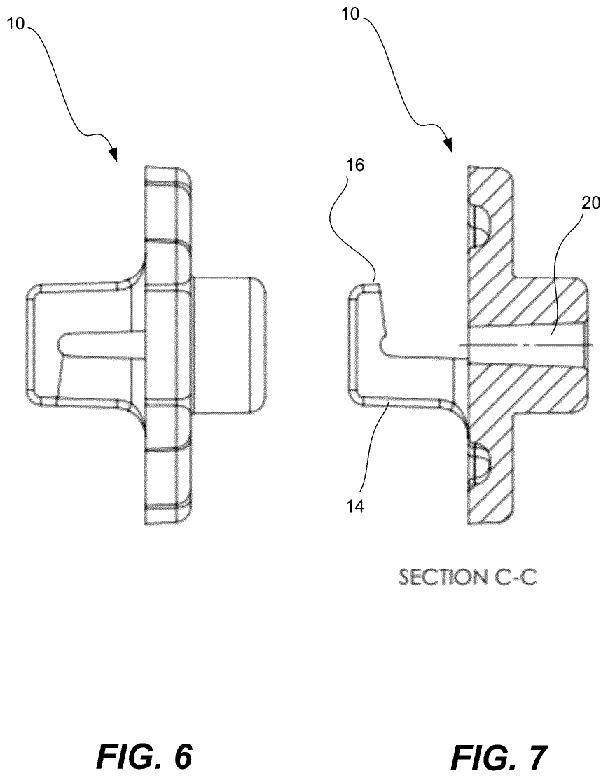

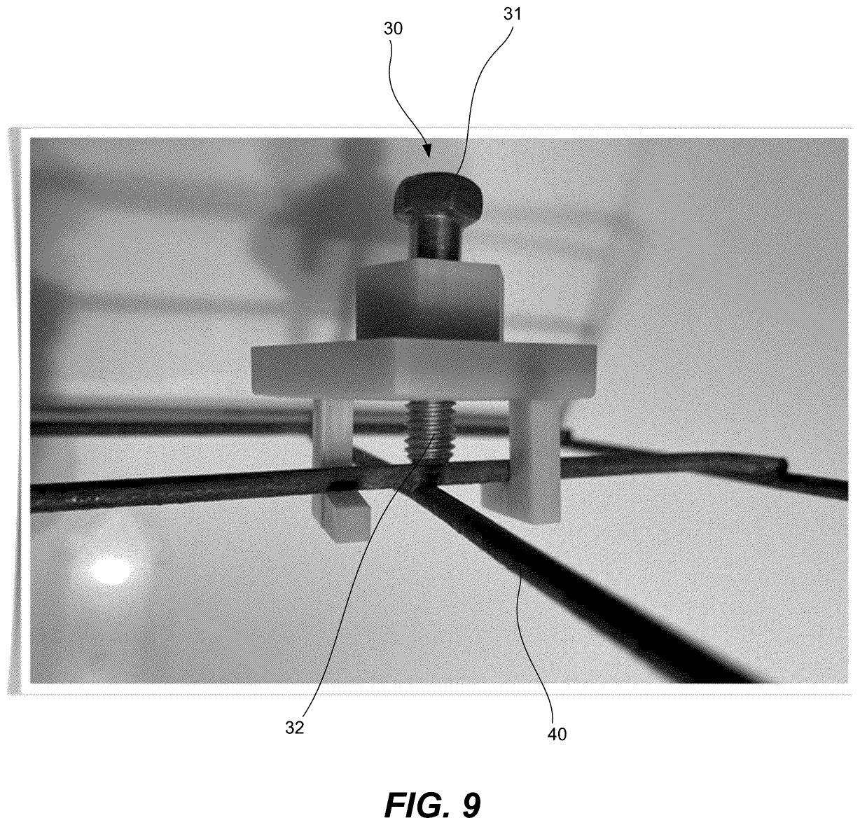

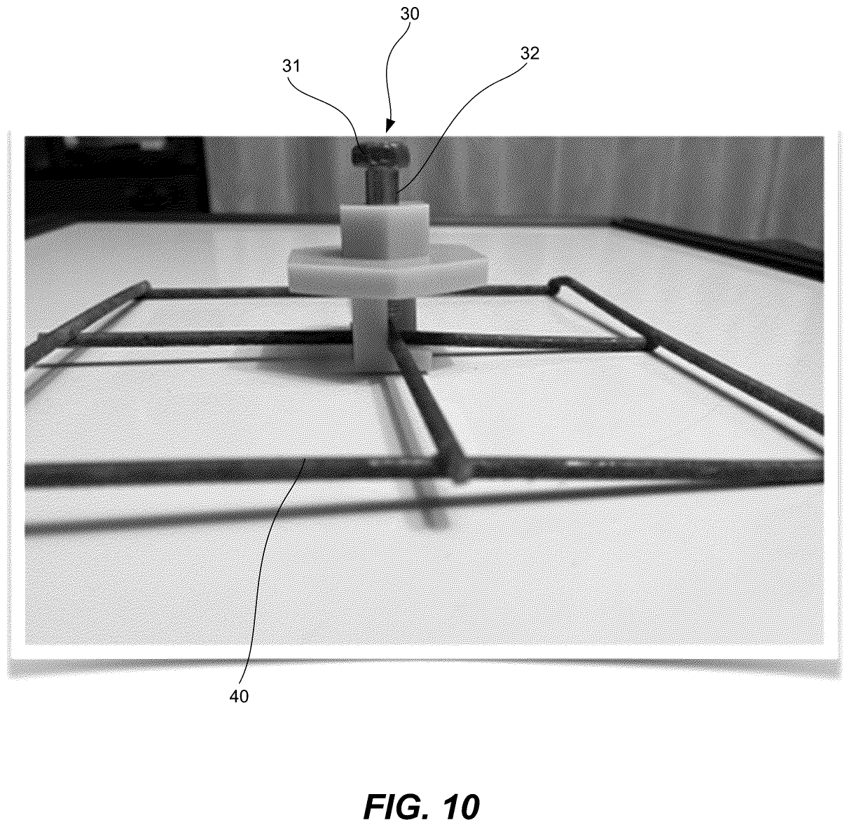

FIGS. 1-10 depict one exemplary embodiment of a shotcrete gauge denoted generally by reference numeral 10. As depicted in the figures, the shotcrete gauge 10 has a main body 12. The main body 12 may have a generally circular periphery with optional gripping lobes 13 to facilitate grasping and turning of the main body when twisting it onto a mesh. As depicted in the figures, the shotcrete gauge 10 has a pair of twist-on members 14 (securing arms) having parallel hooks 16 to attach to a reinforcement mesh disposed against the surface. In this embodiment, the hooks 16 point in opposite directions. FIGS. 8-10 show the shotcrete gauge 10 attached to a reinforcement mesh denoted generally by reference numeral 40. Although the shotcrete gauge in the embodiment illustrated herein is primarily intended to attach to a reinforcement mesh, it will be appreciated that the shotcrete gauge can be used, or readily modified for use, with rebar or other types of reinforcement members. The shotcrete gauge 10 depicted in the figures includes a cylindrical portion 18 having a fastener-supporting bore 20 extending inside the main body. The bore 20 may extend centrally through the main body as shown in the illustrated embodiment. In the illustrated embodiment, the bore 20 has internal threads for receiving a depth-setting fastener 30 (shown in FIGS. 8-10) having corresponding external threads. In another embodiment, the portion of the main body defining the bore is not threaded itself but instead receives a rivet nut that is inserted into the bore of the main body to provide the internal threads to receive the depth-setting fastener. In that embodiment, the rivet nut may have a flange or shoulder to abut a countersunk hole in the main body. For greater clarity it will be understood that the expression “shotcrete gauge” as used in this specification is to be interpreted either as the gauge itself without the fastener or the gauge including at least one depth-setting fastener.

In the illustrated embodiment, the depth-setting fastener 30 is a depth-setting bolt having a bolt head 31 and a threaded shank 32 having the external threads. The bolt head 31 provides a visual indicator for a user applying the shotcrete to the reinforcement mesh. In the specific embodiment illustrated in FIGS. 8-10, the bolt head 31 has a head color different from a shank color. For example, the bolt head 31 may be red as shown to visually distinguish it from the color of the shotcrete, the mesh and the shank of the bolt to enable the user applying the shotcrete to easily see the extent of the bolt. In a variant, instead of a bolt, the depth-setting fastener 30 can be a threaded rod, shafted shaft or other threaded component that can be secured to the internal threads of the bore of the main body.

Optionally, the shotcrete gauge may include a threaded support bracket that replaces the depth-setting fastener after the shotcrete has been applied, the threaded support bracket being adapted to support an object from the reinforcement mesh. The object to be supported may be for example a vent or duct. Alternatively, the object to be supported may be for example a hose (e.g. for pneumatic hose, hydraulic hose, vacuum hose, water hose, etc.) or an electrical line for power and/or communication.

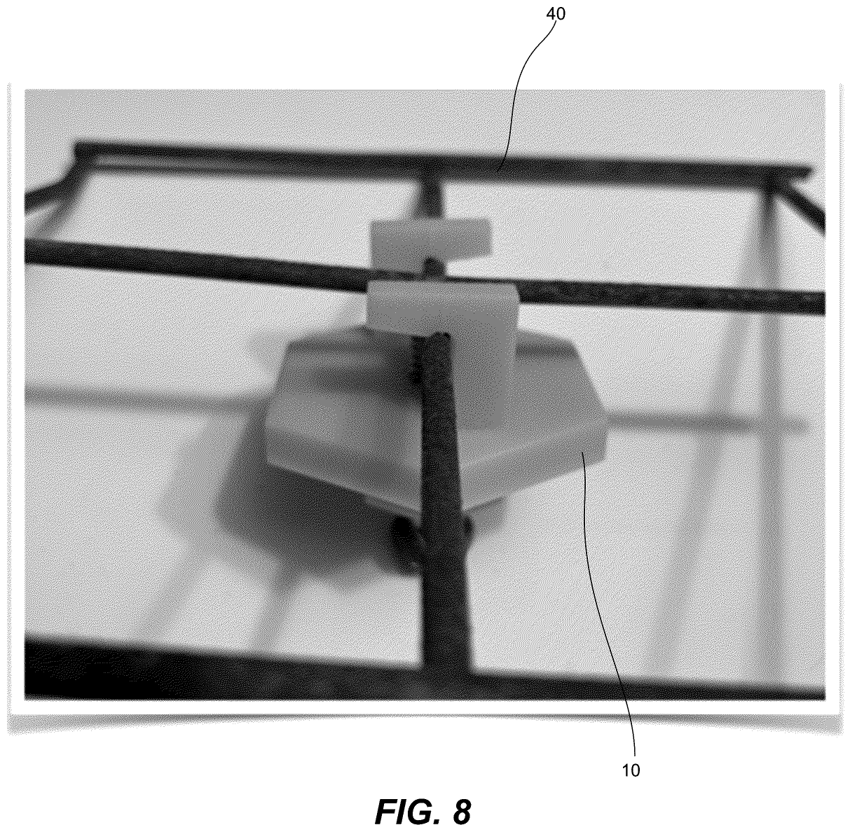

In one embodiment, the shotcrete gauge includes a plurality of bolts of different length. In other words, the depth-setting fastener 30 can be one of a plurality of depth-setting fasteners of different lengths that can be fastened into the fastener-supporting bore to set different thicknesses for applying the shotcrete. Optionally, the geometry (shape and size) of the bore and the bolt are designed to stop the bolt at a predetermined depth corresponding to a prescribed thickness. For example, the bore may be tapered to stop the bolt at a predetermined depth. A tapered bore is shown by way of example in FIG. 7. In variants, as further examples, the bore may have a lip, flange, radial ledge or countersunk step to block the bolt at a predetermined depth. Optionally, the bolt or main body of the shotcrete gauge can include markings, notches, symbols, or numerals representing distance, etc. to show where to set the bolt to achieve different prescribed thicknesses of shotcrete.

As depicted by way of example in FIGS. 1, 2, 4 and 5, the main body 12 of the shotcrete gauge 10 may optionally include holes or passageways 22 extending from a top surface of the main body to an underside surface of the main body. These holes or passageways may be used to pass wires, cables or the like. These holes or passageways may also be used by the person attaching the gauge to the mesh to see the mesh to facilitate attachment. Optionally, the shotcrete gauge may include arcuate grooves 24 formed in the underside of the main body. These optional grooves may be used to connect to heads of other mounting hardware that is attached to a surface to be covered with shotcrete.

Another aspect of the invention is a method of applying shotcrete to a surface using the shotcrete gauge. The method entails steps, acts or operations as following. The method may involve an initial step of attaching a reinforcement mesh to the surface. This may be performed by the shotcrete worker or this may be done by another worker prior to the arrival of the shotcrete worker. Attaching the reinforcement to the surface, e.g. to a surface of tunnel of a mine, may be accomplished using rock bolts or any equivalent means for securing the mesh to the surface. The method of applying shotcrete also entails attaching a shotcrete gauge to the reinforcement mesh. The shotcrete gauge includes as noted above a main body, a pair of twist-on members having parallel hooks to attach to a reinforcement mesh disposed against the surface and a fastener-supporting bore extending centrally inside the main body and having internal threads for receiving a depth-setting fastener having corresponding external threads. The attaching step involve twisting (i.e. rotating) the shotcrete gauge to hook the parallel hooks to the reinforcement mesh. The method also entails fastening the depth-setting fastener in the fastener-supporting bore to set a depth of the shotcrete. It is to be noted that the depth-setting fastener may be threaded into the bore before the shotcrete gauge is attached to the mesh or after the shotcrete gauge is attached to the mesh. The depth-setting fastener may be a depth-setting bolt with a colored head of a different color than the shank of the fastener to provide a visual indicator to the user applying the shotcrete. The depth-setting fastener is then adjusted to the correct depth to provide the desired thickness of the shotcrete. Optionally, the shotcrete gauge comes as a kit with a plurality of different fasteners (different bolts) of varying lengths so that the correct depth can be achieved by selecting the bolt of the desired length. The method is then completed by applying the shotcrete using the shotcrete gauge to visually gauge the thickness of shotcrete to be applied. Optionally, the fastener may be removed and replaced with a threaded support bracket that threads into the bore. The threaded support bracket may then be used to support (e.g. hang or suspend) a hose, a vent or other object. This method may be used in a mine to apply shotcrete to a tunnel or drift. It will be appreciated, however, that this method of applying shotcrete using this shotcrete gauge may be used in any other shotcrete application in any other construction project where it is useful to control the depth or thickness of the shotcrete being applied.

For the purposes of interpreting this specification, when referring to elements of various embodiments of the present invention, the articles “a”, “an”, “the” and “said” are intended to mean that there are one or more of the elements. The terms “comprising”, “including”, “having”, “entailing” and “involving”, and verb tense variants thereof, are intended to be inclusive and open-ended by which it is meant that there may be additional elements other than the listed elements.

This new technology has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1. A shotcrete gauge for facilitating an application of shotcrete to a surface, the shotcrete gauge comprising:
a main body;
a pair of twist-on members having parallel hooks to attach to a reinforcement mesh disposed against the surface; and
a fastener-supporting bore extending centrally inside the main body and having internal threads for receiving a depth-setting fastener having corresponding external threads.

2. The shotcrete gauge of claim 1 comprising the depth-setting fastener.

3. The shotcrete gauge of claim 2 wherein the depth-setting fastener is a depth-setting bolt having a bolt head and a threaded shank having the external threads, wherein the bolt head provides a visual indicator for a user applying the shotcrete to the reinforcement mesh.

4. The shotcrete gauge of claim 3 wherein the bolt head has a head color different from a shank color.

5. The shotcrete gauge of claim 2 comprising a threaded support bracket that replaces the depth-setting fastener after the shotcrete has been applied, the threaded support bracket being adapted to support an object from the reinforcement mesh.

6. The shotcrete gauge of claim 5 wherein the object is a vent.

7. The shotcrete gauge of claim 5 wherein the object is a hose.

8. The shotcrete gauge of claim 1 wherein the depth-setting fastener is one of a plurality of depth-setting fasteners of different lengths that can be fastened into the fastener-supporting bore to set different thicknesses for applying the shotcrete.

9. A shotcrete gauge for applying shotcrete, the shotcrete gauge comprising:
a main body;
a pair of twist-on members having hooks to attach to a reinforcement mesh; and
a fastener-supporting bore extending inside the main body and having internal threads for receiving a depth-setting fastener having corresponding external threads.

10. The shotcrete gauge of claim 9 comprising the depth-setting fastener.

11. The shotcrete gauge of claim 10 wherein the depth-setting fastener is a depth-setting bolt having a bolt head and a threaded shank having the external threads, wherein the bolt head provides a visual indicator for a user applying the shotcrete to the reinforcement mesh.

12. The shotcrete gauge of claim 11 wherein the bolt head has a head color different from a shank color.

13. The shotcrete gauge of claim 10 comprising a threaded support bracket that replaces the depth-setting fastener after the shotcrete has been applied, the threaded support bracket being adapted to support an object from the reinforcement mesh.

14. The shotcrete gauge of claim 13 wherein the object is a vent.

15. The shotcrete gauge of claim 13 wherein the object is a hose.

16. The shotcrete gauge of claim 9 wherein the depth-setting fastener is one of a plurality of depth-setting fasteners of different lengths that can be fastened into the fastener-supporting bore to set different thicknesses for applying the shotcrete.

17. A method of applying shotcrete to a surface, the method comprising:
attaching a reinforcement mesh to the surface;
attaching a shotcrete gauge to the reinforcement mesh, the shotcrete gauge comprising:
a main body;
a pair of twist-on members having parallel hooks to attach to a reinforcement mesh disposed against the surface; and
a fastener-supporting bore extending centrally inside the main body and having internal threads for receiving a depth-setting fastener having corresponding external threads;
fastening the depth-setting fastener in the fastener-supporting bore to set a depth of the shotcrete.

18. The method of claim 17 comprising:
removing the depth-setting fastener; and
fastening a threaded support bracket into the bore.

19. The method of claim 18 comprising hanging a vent or hose from the threaded support bracket.

20. The method of claim 17 wherein the depth-setting fastener is a depth-setting bolt having a bolt head and a threaded shank having the external threads, wherein the bolt head provides a visual indicator for a user applying the shotcrete to the reinforcement mesh, wherein the bolt head has a head color different from a shank color.
